(19) United States
(12) Patent Application Publication
(10) Pub. No.: US 2006/0125246 A1
(43) Pub. Date: Jun. 15, 2006

(54) Hood latch assembly with integral ajar switch

(76) Inventors: Tony Lau, Markham (CA); Grzegorz Bernardyn, Newmarket (CA)

Correspondence Address: CLARK HILL, P.C., 500 WOODWARD AVENUE, SUITE 3500, DETROIT, MI, 48226, US

(21) Appl. No.: 11/290,867

(22) Filed: Nov. 30, 2005

Related U.S. Application Data
(60) Provisional application No. 60/631,754, filed on Nov. 30, 2004.

(51) Int. Cl. E05C 3/06

(52) U.S. Cl. 292/216

(57) ABSTRACT

A latch assembly for a vehicle hood that includes a housing with a ratchet and pawl mounted to the housing. The ratchet and pawl cooperatively move between a closed position to hold a striker and an open position to release a striker. A secondary catch is pivotally mounted to the same axis as the ratchet and retains the striker in a secondary position upon release of the ratchet. A switch assembly mounted to the housing includes a switch presented towards the ratchet along a common plane. A plug connector for a wiring harness is located on an end of the switch assembly outside of the housing at an angle substantially perpendicular to the striker path on the side of the housing opposite the side adapted to receive the striker. Rotating the ratchet between the open and closed position moves the cam profile, engaging or disengaging the switch assembly.

### FIELD OF THE INVENTION

The invention relates to a vehicle latches. More specifically, the present invention relates to a hood latch with an integral ajar switch.

### BACKGROUND OF THE INVENTION

A hood ajar switch improves the safety of a vehicle when the vehicle is packaged with a remote starter. The hood ajar switch provides a signal to an electronic control unit (ECU) or module of the vehicle indicating whether or not the hood primary latch is in the open or closed position. The remote starter is prevented from operating when the hood primary latch is in the open position, thus protecting the operator from injury when the hood is open for maintenance.

The function of the ajar switch is to detect the status of the primary latch position and send an electronic signal to the vehicle to ECU to indicate the closure status of the hood. In current hood latches, the ajar switch is mounted on the latch to interface with an operating lever of the latch. More particularly, the latch ratchet has a bent tab that engages the switch rocker. The switch is connected via a local wire harness to a plug connector that interconnects the switch to the main wiring system of the vehicle. A significant problem with the current design is that the local wiring harness can shift position and interfere with the moving parts of the latch, and thus tear or rip. In addition, because a bent tab is used to actuate the ajar switch, the placement of the tab is critical to the effective engagement of the switch. If the load on the latch presented by the hood changes substantially (or if a different hood is destined for use with the same latch), the ratchet may not properly actuate the switch. Another problem presented by the current ajar switch design is an installation problem. Because the plug connector floats freely, the assembler must use a two handed operation to attach the ajar switch plug connector to another complementary connector of the main vehicle wiring harness.

### SUMMARY OF THE INVENTION

According to a first aspect of the invention, there is provided a latch assembly for retaining a vehicle hood. The latch assembly includes:

a housing;

a ratchet and pawl mounted to the housing, the ratchet and pawl cooperatively operable to move between a closed position to hold a striker and an open position to release a striker;

a cam profile located along a portion of the ratchet's perimeter;

a switch assembly, mounted to the housing that includes a switch presented on a common plane towards the ratchet; and

wherein the cam profile engages the switch when the ratchet is rotated to one of the open and closed positions, and disengages the switch when the ratchet is rotates to the other of the open and closed positions.

According to a second aspect of the invention, there is provided a latch assembly for retaining a vehicle hood. The latch assembly includes:

a housing;

a ratchet and pawl mounted to the housing, the ratchet and pawl cooperatively operable to move between a closed position to hold a striker and an open position to release a striker;

a switch assembly, mounted to the housing that includes a switch presented towards the ratchet;

a plug connector operable to be connected to a wiring harness located on an end of the switch assembly and extending outside of the housing at an angle substantially perpendicular to the path of movement of the striker and on the side of the housing opposite the side adapted to receive the striker; and

wherein rotating the ratchet to one of the open and closed position engages the switch assembly, and rotating the ratchet to the other of the open and closed positions position disengages from the switch assembly.

The invention provides a switch assembly for structurally incorporating the ajar switch and its requisite wiring interconnections into the housing of the latch. This provides operational, corrosion and weathering protection. In addition, the latch ratchet is designed to include a cam profile for engaging the ajar switch. The cam profile is set up to effectively engage (or disengage) the ajar switch substantially irrespective of load changes. The ajar switch assembly also allows a more economical installation process. The invention also enables a one handed “snap in” motion to attach the ajar switch plug connector to another complementary connector of the main vehicle wiring harness.

### BRIEF DESCRIPTION OF THE DRAWINGS

The foregoing and other aspects of the invention will be better understood from the following detailed description of preferred embodiments thereof in conjunction with the drawings, wherein:

FIG. 1 is a perspective view of a latch assembly incorporating an integral ajar switch according to a first aspect of the invention;

FIG. 2 is an isolated perspective view of the integral ajar switch shown in FIG. 1;

FIG. 3 is a top plan view of the latch assembly shown in FIG. 1 wherein the ajar switch is engaged; and

FIG. 4 is a perspective view of a portion the latch assembly shown in FIG. 1 wherein the ajar switch is engaged.

### DETAILED DESCRIPTION OF THE INVENTION

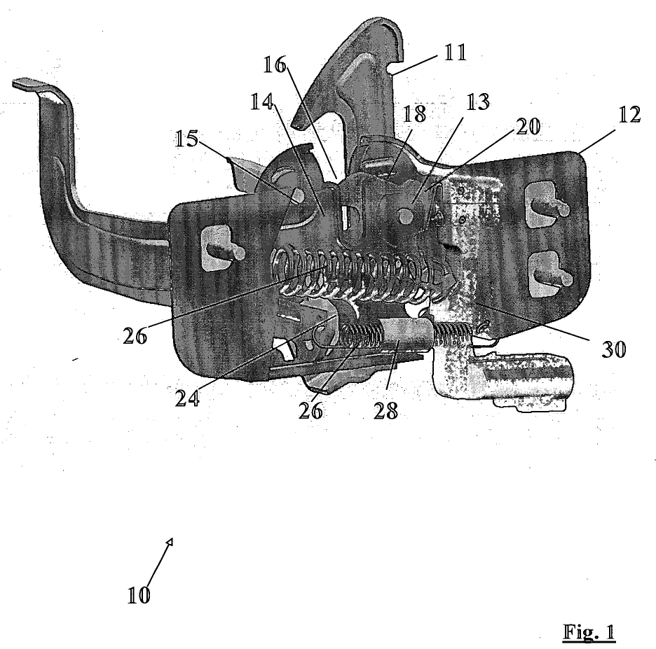

Referring to FIG. 1, a hood latch assembly is shown generally at 10. Hood latch assembly 10 is operable to retain a latch striker (not shown) in either a ‘primary closed’ position or a ‘secondary closed’ position. Hood latch assembly 10 includes a secondary catch 11, and a metal housing 12 which encloses the remaining parts of the latch assembly. Secondary catch 11 is pivotally mounted to housing 12 along a rivet 13 and is movable between an ‘open’ position and a ‘closed’ position. Upon release of the striker, hood latch assembly 10 moves from the primary release position to the secondary release position. A secondary spring (not shown), preferably a torsion spring, biases secondary catch 11 to the closed position to prevent it from self-releasing. In order to release the vehicle hood into a released position, a user must manually pivot the secondary catch 11 into the open position to allow the striker to be fully withdrawn.

The housing 12 is the main frame of the hood latch assembly 10 containing all the components of the latch assembly and is directly bolted onto the vehicle body (not shown). Housing 12 encloses a plurality of additional components. A reinforcing cover plate 14 attaches onto the housing 12 via a pair of rivets 13 and 15. The cover plate 14 guides the striker (not shown) into the closed position of latch assembly 10 via a fishmouth 16.

A ratchet 18, preferably formed from metal, is pivotally mounted onto the housing 12 by rivet 13. Ratchet 18 rotates between an ‘engaged’ position to retain the striker (when latch assembly 10 is in the primary closed position) and an ‘released’ position allowing the latch striker to exit fishmouth 16 (moving latch assembly 10 to the secondary closed position). The ratchet 18 includes a cam profile 20 which activates/deactivates an ajar switch assembly 30, as described in greater detail below.

A pawl 22, preferably formed from metal, is pivotally mounted onto the housing 12, and is movable between an open and a closed position. The pawl 22 includes a cam profile (not shown) on one end thereof to lock the ratchet 18 in the engaged position when the pawl is in its closed position. The other end of the pawl 22 connects to a cable (not shown) for pivoting pawl 22 into the open position, thereby releasing the ratchet 18 from its engaged position to the released position. An extension spring 24 biases the ratchet 18 in either the engaged or released position. A pawl spring 26 biases pawl 22 in either the open or closed position. A dampener 28 is provided, which absorbs vibrations and reduces noise for pawl spring 26.

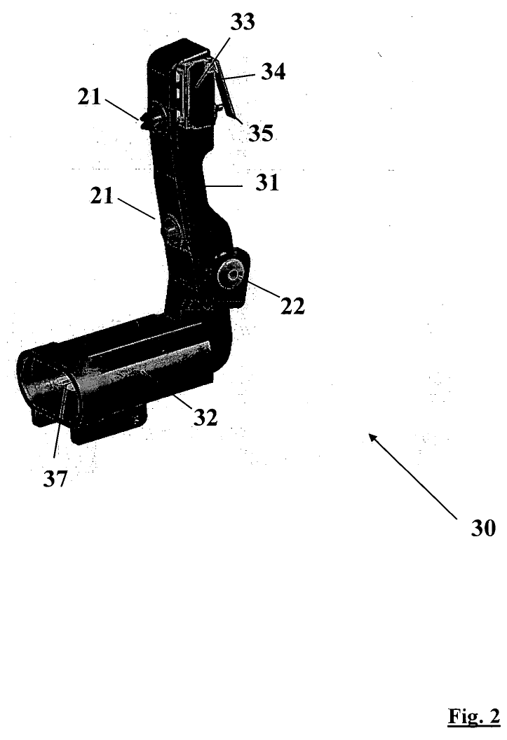

The switch assembly 30 detects the open or closed position of ratchet 18 (thereby indicating whether latch assembly 10 is in the primary closed position or not) and transmits this information to the vehicle's ECU (not shown). Referring additionally to FIG. 2, a portion of the switch assembly 30 is located within the housing 12 via two dial pins 21. Once located, the assembly is mounted to the housing 12 by an assembler via a pop rivet 22.

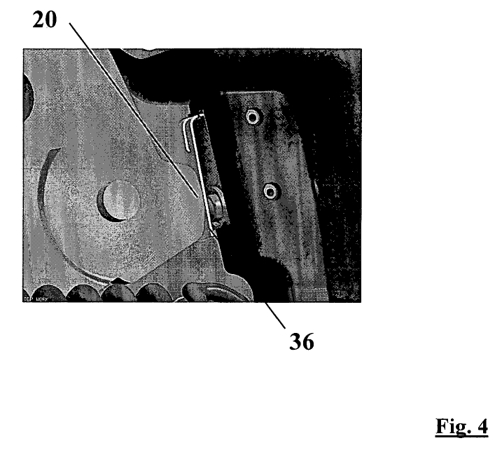

The switch assembly 30 preferably includes a substantially solid plastic body 31 which includes an integral plug connector 32. The body 31 includes a cavity for mounting a hood ajar switch 33, including a biased switch rocker 34 (which may be provided for example by a leaf spring) and button 35. More particularly, the hood ajar switch 33 is mounted so that the rocker extends from a face 36 (FIG. 4) of the assembly, opposing the ratchet 18. The assembly face 36 lies in substantially the same plane as the ratchet 18 so that as the ratchet pivots into either the open or the closed position, its cam profile 20 engages and subsequently disengages the switch rocker 34. It is contemplated that other switches may be mounted within body 31.

The integral plug connector 32 includes a plurality of blades 37 for attachment to a complementary connector associated with the main wiring harness (not shown) of the vehicle. The blades are connected to rigid metallic traces (not specifically shown) encased by the plastic body 31 in order to provide the electrical interconnection between the plug connector blades and the switch. In practice, this structure may be manufactured by over-molding the traces in an injection molding process. The traces are connected to the terminals of the ajar switch 33 by soldering process. The plastic body thus provides an operational protection since the electrical connection between the plug connector blades and switch is now physically fixed in location, precluding damage during operation of hood latch assembly 10. The plastic body also provides good corrosion protection. Moreover, with the plug connector 32 being integrally and solidly attached to the hood latch assembly 10, the assembler can use a one-handed operation to attach the ajar switch plug connector 32 to the main wiring harness of the vehicle.

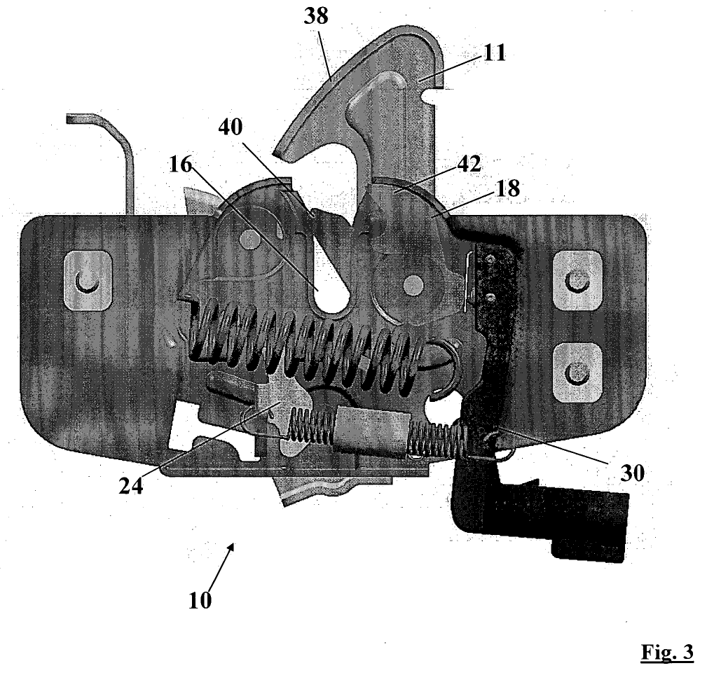

Referring now to FIGS. 3 and 4, operation of latch assembly 10 is shown in greater detail. When the hood (not shown) is pushed down to be closed, the striker (not shown) engages a top profile 38 of the secondary catch 11, forcing the secondary catch 11 to rotate around rivet 13 on the housing 12 into the open position. After the striker passes the secondary catch 11, the secondary catch 11 goes back to its closed position due to the secondary catch spring (not shown). After that, the striker, guided by a fish-mouth 16 on the cover plate 14, hits the inside surface of the ratchet 18, pushing the ratchet 18 to its engaged position. Simultaneously, the other end of the ratchet 18 a cam profile 40 rotates and pushes the pawl 22 to lock the latch assembly 10 in its ‘primary closed’ position. When the ratchet 18 rotated into its engaged position, cam profile 20 is rotated away from the switch rocker 35. The switch signal is turned off; meaning the biased switch rocker is under no load.

The latch assembly 10 is released by pulling a cable with one end attached to the pawl 22. When the pawl 22 rotates, the ratchet 18 slips out of its engaged position due to the ratchet spring 26, which exerts a force to rotate the ratchet 18 back in its released direction. The ratchet 18 motion is stopped when a top cam profile 42 on the ratchet 18 hits the inner surface of the housing 12. Simultaneously, the cam profile 20 of the ratchet 18 compresses the switch rocker 35 to turn on the ajar signal which is sent to the vehicle's ECU.

The switch assembly 30 is sealed inside the plastic body 31. It operates within the temperature range of −40 to 105° C. and can work in all weather conditions. Switch assembly 19 is designed with corrosion resistance. Hood latch assembly 10 can be used in multiple configurations with or without the switch assembly 19. The switch assembly 30 is provided in a small package that doesn't require any additional harness; the switch is integrated, and the plug connector is positioned in the body with water and corrosion resistance.

What is claimed is:

1. A latch assembly for retaining a vehicle hood, comprising:
a housing;
a ratchet and pawl mounted to the housing, the ratchet and pawl cooperatively operable to move between a closed position to hold a striker and an open position to release a striker;
a cam profile located along a portion of the ratchet's perimeter;
a switch assembly, mounted to the housing that includes a switch presented on a common plane towards the ratchet; and
wherein the cam profile engages the switch when the ratchet is rotated to one of the open and closed positions, and disengages the switch when the ratchet is rotates to the other of the open and closed positions.

2. The latch assembly of claim 1, further including a secondary catch pivotally mounted to the housing and operable to retain the striker upon release of the striker from the ratchet.

3. The latch assembly of claim 2, wherein the housing includes an aperture and a portion of the switch assembly extends through the aperture into the housing.

4. The latch assembly of claim 3, wherein the switch assembly is mounted to an interior wall of the housing.

5. The latch assembly of claim 1, wherein the switch assembly includes a plug connector operable to be connected to a wiring harness.

6. The latch assembly of claim 5, wherein the plug connector is presented outside of the housing.

7. The latch assembly of claim 6, wherein the plug connector is presented at an angle substantially perpendicular to the path of movement of the striker.

8. The latch assembly of claim 7, wherein the plug connector is located on an end of the switch assembly on the side of the housing opposite the side adapted to receive the striker.

9. The latch assembly of claim 5, wherein the switch assembly is connected to an electronic control unit on the vehicle via the wiring harness.

10. The latch assembly of claim 5, wherein the plug connector provides an environmental seal for the wiring harness.

11. The latch assembly of claim 4, wherein the switch assembly includes at least one dial pin operable to locate the correct position of the switch assembly within the housing.

12. A latch assembly for retaining a vehicle hood, comprising:
a housing;
a ratchet and pawl mounted to the housing, the ratchet and pawl cooperatively operable to move between a closed position to hold a striker and an open position to release a striker;
a switch assembly, mounted to the housing that includes a switch presented towards the ratchet;
a plug connector operable to be connected to a wiring harness located on an end of the switch assembly and extending outside of the housing at an angle substantially perpendicular to the path of movement of the striker and on the side of the housing opposite the side adapted to receive the striker; and
wherein rotating the ratchet to one of the open and closed position engages the switch assembly, and rotating the ratchet to the other of the open and closed positions position disengages from the switch assembly.
